(19) United States
(12) Patent Application Publication
(10) Pub. No.: US 2019/0036448 A1
(43) Pub. Date: Jan. 31, 2019

(54) POWER FACTOR IMPROVEMENT CIRCUIT AND DC/DC CONVERTER

(71) Applicant: SANKEN ELECTRIC CO., LTD., Saitama (JP)

(72) Inventor: Hiromitsu TERUI, Niiza-Shi, Saitama (JP)

(73) Assignee: SANKEN ELECTRIC CO., LTD., Saitama (KR)

(21) Appl. No.: 16/070,875

(22) PCT Filed: Jan. 19, 2016
(86) PCT No.: PCT/JP2016/051383

§ 371 Date: Jul. 18, 2018

(51) Int. Cl. H02M 1/42; H02M 3/158; H02M 7/217

(52) U.S. Cl. CPC H02M 1/4266; H02M 7/2176; H02M 3/1582

(57) ABSTRACT

The present invention is provided with: a series circuit consisting of a coil and a switching element; a rectifying and smoothing circuit consisting of a rectifying element and a smoothing capacitor; a calculating unit configured to calculate a multiplied voltage, obtained by multiplying an error voltage between an output voltage of the smoothing capacitor and a reference voltage by an output of the rectifying circuit, and a voltage corresponding to a current flowing through the switching element or a current from the output terminal of the rectifying circuit; a superimposing circuit configured to superimpose a signal based on the output of the rectifying circuit on a reference signal of a reference oscillator; and a control circuit configured to generate a pulse signal by comparing an output of the superimposing circuit with an output from the calculating unit, and turn on/off the switching element with the pulse signal.

### CROSS REFERENCE TO RELATED APPLICATION

This application is a National Stage of International Application No. PCT/JP2016/051383, filed on Jan. 19, 2016, and published in Japanese as WO2017/126023 A1 on Jul. 27, 2017, which is hereby incorporated by reference in its entirety.

### TECHNICAL FIELD

The present invention relates to a power factor improvement circuit and a DC/DC converter having a high power factor and a high stability.

### BACKGROUND

As described in Patent document 1, a conventional Current Continuous Mode Power Factor Improvement Circuit (CCMPFC) detects an output voltage, and performs a power factor improvement control based on the detected output voltage.

Further, as described in Patent document 2, in order to improve the responsiveness of a fluctuation of an input voltage, a conventional CCMPFC inputs the fluctuation of the input voltage to a feedback loop of the output voltage, and controls the output voltage.

FIG. 1 is a circuit structure diagram of a conventional power factor improvement circuit. In FIG. 1, the current continuous mode power factor improvement circuit uses a rectifier 2 to perform a bridge rectification on an AC voltage of an AC power supply 1, converts a rectified output VIN after the rectification into a DC voltage and supplies an output voltage Vo to a load not illustrated, so as to perform a power factor improvement.

As illustrated in FIG. 1, the Power Factor Improvement Circuit (PFC) is a boost type power factor improvement circuit, and includes a coil L1, a switching element Q1, a first diode D1, an output capacitor Cout, and a control circuit 3A. In addition, in the PFC circuit, a high-frequency switch control signal is output from the control circuit 3A to the switching element Q1, so as to control the switching element Q1 to be turned on/off at a high frequency. Thus, the current flowing through the coil L1 is turned on/off at a high frequency to improve the power factor, and the output voltage Vo of the PFC circuit is boosted.

As illustrated in FIG. 1, the control circuit 3A includes an error amplifier 30, a multiplier 31, a reference oscillator 32, a calculating unit 33, a PWM comparator 34, and a drive circuit 35. The error amplifier 30 amplifies an error voltage between a feedback voltage VFB and a reference voltage Vref and outputs it as an output voltage Comp, wherein the feedback voltage VFB is a voltage obtained by dividing the output voltage Vo using a resistor R3 and a resistor R4. The multiplier 31 multiplies a rectified divided voltage VAC by the output voltage Comp of the error amplifier 30 and sets the resulting value as a target value of the input current, wherein the rectified divided voltage VAC is obtained by dividing the rectified output VIN, that is rectified by the rectifier 2, using the resistor R1 and the resistor R2.

A current detection resistor R6 outputs a voltage corresponding to a current flowing through the switching element Q1 to an inverting input terminal of the calculating unit 33. The calculating unit 33 calculates the voltage corresponding to the current detected by the current detection resistor R6 according to a multiplication output from the multiplier 31, and outputs a signal Vx to a non-inverting input terminal of the PWM comparator 34. A series circuit of a resistor R7 and a capacitor C1 for phase correction is connected to an output terminal of the calculating unit 33.

The PWM comparator 34 compares the signal Vx from the calculating unit 33 with a sawtooth wave signal Vsaw from the reference oscillator 32 and performs a control to generate a current similar to the input voltage, so as to perform a power factor improvement operation. The duty cycle of the switching element Q1 becomes an appropriate value through the feedback control described above. The control circuit 3A detects the output voltage Vo, and controls the duty cycle of the switching element Q1 according to the output voltage Vo, so that the output voltage Vo is a specified value.

### PRIOR ART DOCUMENTS

### Patent documents

Patent Document 1: Japanese Laid-Open Patent Publication No. H2-7869;

Patent Document 2: Japanese Laid-Open Patent Publication No. 2013-63003.

### SUMMARY

### Problem to be Solved by the Present Invention

However, in order to make an average value of an input current I1 be similar to the rectified output VIN after the rectified output VIN is detected, the control circuit 3A requires a response time, and the response time is generated due to a delay of a time constant of the resistor R7 and the capacitor C1 which serve as a phase correction circuit of the calculating unit 33. Therefore, the average value of the input current I1 becoming similar to the rectified output VIN delays the response time.

In order to shorten the response time, it is necessary to adjust the time constant of the resistor R7 and the capacitor C1 which serve as the phase correction circuit of the calculating unit 33, so as to shorten the response time. However, the stability is decreased due to the adjustment of the phase correction of the calculating unit 33.

In addition, in Patent document 2, since the fluctuation of the input voltage is input to the feedback loop of the output voltage, the response time of the output voltage is shortened when the input voltage varies, however, the delay of the input current I1 related to the power factor improvement cannot be improved.

An object of the present invention is to provide a power factor improvement circuit and a DC/DC converter, which can achieve both a high power factor and improvement of the stability with a simple structure.

### Means for Solving the Problem

In order to solve the problem, the power factor improvement circuit of the present invention includes: a rectifying circuit configured to rectify an AC voltage of an AC power supply; a series circuit consisting of a coil and a switching element connected in series to an output terminal of the rectifying circuit; a rectifying and smoothing circuit consisting of a rectifying element and a smoothing capacitor connected in series between main electrodes of the switching element; a calculating unit configured to calculate a multiplied voltage and a voltage corresponding to a current flowing through the switching element or a current from the output terminal of the rectifying circuit, said multiplied voltage being obtained by multiplying an error voltage between an output voltage of the smoothing capacitor and a reference voltage by an output of the rectifying circuit; a reference oscillator configured to generate a reference signal; a superimposing circuit configured to superimpose a signal based on the output of the rectifying circuit on the reference signal of the reference oscillator; and a control circuit configured to generate a pulse signal by comparing an output of the superimposing circuit with an output from the calculating unit, and turn on/off the switching element with the pulse signal.

### Effect of the Invention

According to the present invention, the control circuit can realize both a high power factor and improvement of the stability by combining a feedback control and a feedforward control, wherein the feedback control is achieved through an error voltage between an output voltage of the smoothing capacitor and a reference voltage, and the feedforward control is achieved by comparing the error voltage with a signal obtained by superimposing the signal based on the output of the rectifying circuit on the output of the reference signal.

### BRIEF DESCRIPTION OF DRAWINGS

FIG. 1 is a circuit structure diagram of a conventional power factor improvement circuit.

FIG. 2 is a circuit structure diagram of a power factor improvement circuit of Embodiment 1.

FIG. 3 is a circuit structure diagram of a superimposing circuit disposed in the power factor improvement circuit of Embodiment 1.

FIG. 4 is a waveform diagram for explaining each part of the operation of the PWM comparator of the conventional power factor improvement circuit.

FIG. 5 is a waveform diagram for explaining each part of the operation of the PWM comparator of the power factor improvement circuit of Embodiment 1.

FIG. 6 is a circuit structure diagram of a power factor improvement circuit of Embodiment 2.

FIG. 7 is a circuit structure diagram of a power factor improvement circuit of Embodiment 3.

FIG. 8 is a circuit structure diagram of a superimposing circuit disposed in the power factor improvement circuit of Embodiment 3.

FIG. 9 is a circuit structure diagram of a power factor improvement circuit of Embodiment 4.

FIG. 10 is a circuit structure diagram of a superimposing circuit disposed in the power factor improvement circuit of Embodiment 4.

FIG. 11 is a circuit structure diagram of a boost type DC/DC converter of Embodiment 5.

FIG. 12 is a circuit structure diagram of a buck type DC/DC converter of Embodiment 6.

FIG. 13 is a circuit structure diagram of a boost and buck type DC/DC converter of Embodiment 7.

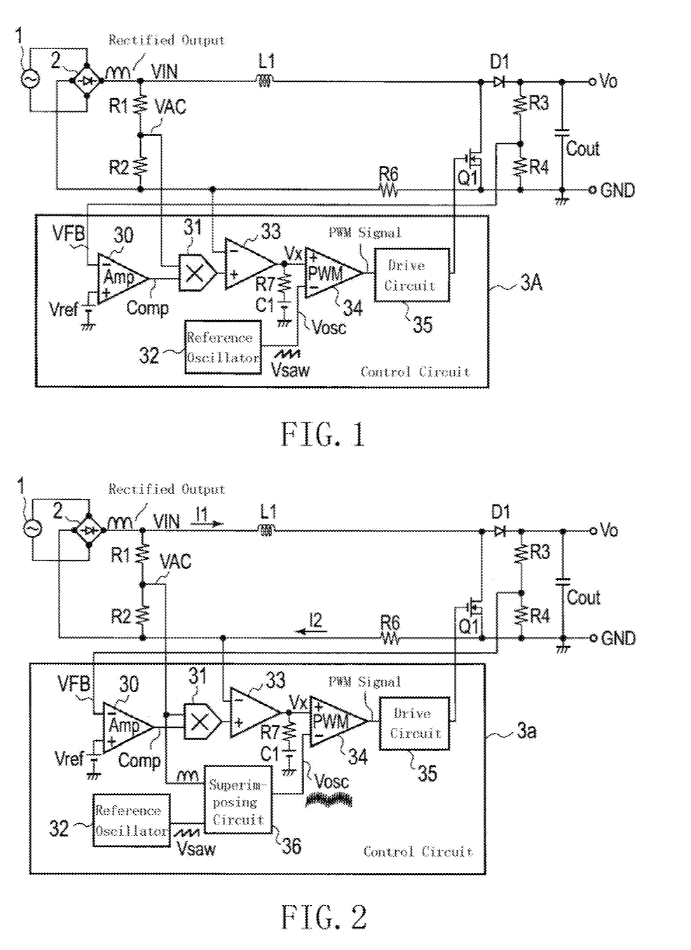

### DESCRIPTION OF EMBODIMENTS

Hereinafter, the embodiments of the power factor improvement circuit and the DC/DC converter of the invention will be described with reference to the accompanying drawings. Herein, the current continuous mode power factor improvement circuit is described as a power factor improvement circuit.

### Embodiment 1

FIG. 2 is a circuit structure diagram of a power factor improvement circuit of Embodiment 1. In FIG. 2, the power factor improvement circuit is a boost type power factor improvement circuit and includes an AC power supply 1, a rectifier 2, a coil L1, a switching element Q1, a first diode D1, an output capacitor Cout, and a control circuit 3a.

The rectifier 2 performs a full-wave rectification on an AC voltage input from the AC power supply 1 and outputs a rectified output VIN. A resistor R1 and a resistor R2 output a rectified divided voltage output VAC obtained by resistively dividing the rectified output VIN.

The coil L1 and the switching element Q1 consisting of a MOSFET are connected in series to the output terminal of the rectifier 2. An anode of a diode D1 is connected to a connection point between the coil L1 and the switching element Q1, and a cathode of the diode D1 is grounded via the smoothing capacitor Cout.

The series circuit of the resistor R1 and the resistor R2 is connected, as a voltage dividing resistor, to the output terminal of the rectifier 2. In addition, the series circuit of a resistor R3 and a resistor R4 is connected, as a voltage dividing resistor, to both ends of the smoothing capacitor Cout.

A rectified divided voltage output VAC based on a voltage dividing ratio between the resistor R1 and the resistor R2, and a feedback voltage VFB based on a voltage dividing ratio between the resistor R3 and the resistor R4 are input to the control circuit 3a. The control circuit 3a generates a drive signal according to the rectified divided voltage output VAC and the feedback voltage VFB, and outputs the drive signal to a gate of the switching element Q1. Preferably, the voltage dividing ratios for obtaining the rectified divided voltage output VAC and the feedback voltage VFB are set to be equal to each other by using a feedforward operation described later.

A current detection resistor R6 is connected between the resistor R2 and a terminal connected to a grounded terminal GND of the switching element Q1. The current detection resistor R6 converts a current I2 flowing between a GND-side terminal of the switching element Q1 and the resistor R2 into a voltage, and outputs the converted voltage to the inverting terminal of the calculating unit 33. In addition, as for the current I2, the same current as the current I1 serving as the input current of the PFC and the output current of the rectifier 2 flows.

The control circuit 3a includes an error amplifier 30, a multiplier 31, a reference oscillator 32, a calculating unit 33, a PWM comparator 34, a drive circuit 35, and a superimposing circuit 36.

The error amplifier 30 amplifies an error voltage between a feedback voltage VFB and a reference voltage Vref and outputs it as an output voltage Comp, wherein the feedback voltage VFB is a voltage obtained by dividing the output voltage Vo using the resistor R3 and the resistor R4. The multiplier 31 multiplies a rectified divided voltage output VAC by the output voltage Comp of the error amplifier 30 and sets the resulting value as a target value of the input current, wherein the rectified divided voltage output VAC is obtained by dividing the rectified output VIN, that is rectified by the rectifier 2, using the resistor R1 and the resistor R2.

The current detection resistor R6 outputs a voltage corresponding to a current flowing through the switching element Q1 to an inverting input terminal of the calculating unit 33. The calculating unit 33 calculates a voltage corresponding to the current detected by the current detection resistor R6 according to a multiplication output from the multiplier 31, and outputs a signal Vx to a non-inverting input terminal of the PWM comparator 34. A series circuit of a resistor R7 and a capacitor C1 for phase correction is connected to an output terminal of the calculating unit 33.

The reference oscillator 32 generates a sawtooth wave signal Vsaw as a reference signal, and outputs the sawtooth wave signal Vsaw to the superimposing circuit 36. The superimposing circuit 36 superimposes the sawtooth wave signal Vsaw from the reference oscillator 32 on the rectified divided voltage output VAC and outputs it as a superimposed signal Vosc to the inverting input terminal of the PWM comparator 34, wherein the rectified divided voltage output VAC is obtained by dividing the rectified output VIN, that is rectified by the rectifier 2, using the resistor R1 and the resistor R2.

The PWM comparator 34 is corresponding to the control circuit of the present invention, by comparing the signal Vx from the calculating unit 33 with the superimposed signal Vosc from the superimposing circuit 36, a pulse signal PWM is generated and output to the drive circuit 35. That is, the PWM comparator 34 performs a feedforward control by comparing the superimposed signal Vosc with the signal Vx, and the phase correction of the calculating unit 33 can be alleviated. The feedforward control will be described later in detail.

The drive circuit 35 turns on and off the switching element Q1 by applying a drive signal to a gate of the switching element Q1. The PWM comparator 34 is able to control the output voltage Vo to be constant by controlling a duty cycle serving as a switching ratio of the switching element Q1.

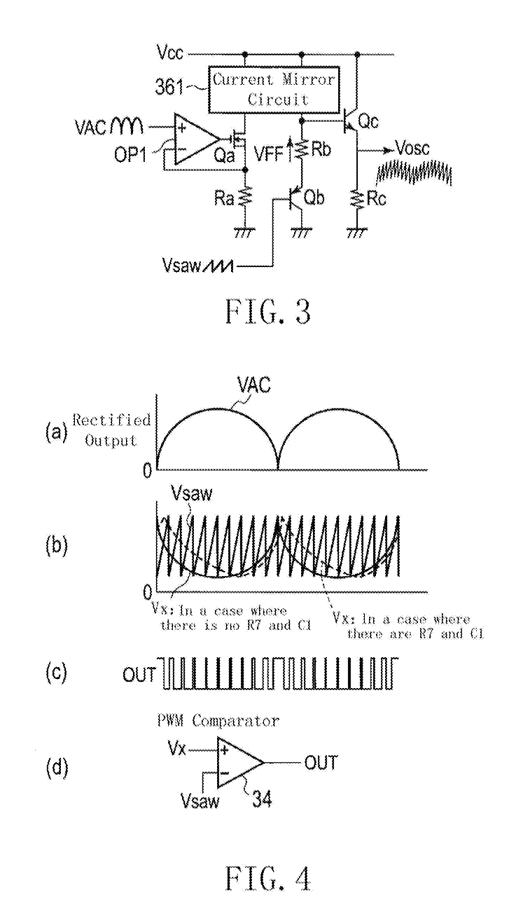

FIG. 3 is a circuit structure diagram of a superimposing circuit 36. The superimposing circuit 36 comprises a current mirror circuit 361, an operational amplifier OP1, a resistor Ra, a resistor Rb, a resistor Rc, an N-type MOSFET Qa, a PNP bipolar transistor Qb, and an NPN bipolar transistor Qc.

The rectified divided voltage output VAC is input to a non-inverting input terminal of the operational amplifier OP1. An inverting input terminal of the operational amplifier OP1 is connected to a source of the MOSFET Qa and grounded via the resistor Ra. A gate of the MOSFET Qa is connected to an output terminal of the operational amplifier OP1, and a drain thereof is connected to the current mirror circuit 361. A power supply Vcc is applied to the current mirror circuit 361.

The leakage current of the MOSFET Qa flows through the resistor Rb and the transistor Qb connected in series via the current mirror circuit 361. An emitter of the transistor Qb is connected to the resistor Rb, and a collector of the transistor Qb is grounded. The sawtooth wave signal Vsaw is input from the reference oscillator 32 to a base of the transistor Qb.

A base of the transistor Qc is connected to a connection point between the resistor Rb and the current mirror circuit 361. A collector of the transistor Qc is connected to the power supply Vcc, an emitter of the transistor Qc is connected to one end of the resistor Rc, and the other end of the resistor Rc is grounded. An emitter of the transistor Qc becomes an output terminal of the superimposing circuit 36 to output the superimposed signal Vosc.

According to the superimposing circuit 36 as illustrated in FIG. 3, the rectified divided voltage output VAC is converted into a current by the resistor Ra, and the converted current is converted into a voltage by the resistor Rb via the current mirror circuit 361. The voltage VFF of the resistor Rb is represented by equation (1).

$$VFF = \frac{Rb}{Ra} VAC \qquad ( 1 )$$

The superimposed signal Vosc is a voltage obtained by superimposing the sawtooth wave output Vsaw on the voltage VFF, and it is represented by equation (2). Herein, a voltage VBE1 is a base-emitter voltage of the transistor Qb, and VBE2 is a base-emitter voltage of the transistor Qc. A ratio of the rectified output VAC to the superimposed signal Vosc can be adjusted by changing a ratio of the resistor Ra to the resistor Rb. That is, the feedforward amount can be adjusted by changing the ratio of the resistor Ra and the resistor Rb.

$$Vosc = Vsaw + VFF = Vsaw + VBE 1 + VFF - VBE 2 = Vsaw + \frac{Rb}{Ra} VAC \qquad ( 2 )$$

Next, the operation of the feedforward control will be described in detail. In the conventional CCMPFC control, the multiplier 31 multiplies the rectified divided voltage output VAC by the output voltage Comp of the error amplifier 30, the calculating unit 33 performs a calculation on the current output from the rectifier 2 according to an output value of the multiplier 31 to obtain a voltage Vx. The PWM comparator 34 compares the voltage Vx with the sawtooth wave output Vsaw. In the conventional CCMPFC control, a current similar to the input voltage is generated by comparing a value, obtained by multiplying the rectified divided voltage output VAC by the output voltage Comp, with the GND current I2, so as to perform a power factor improvement operation.

The duty cycle of the switching element Q1 becomes a proper value through a feedback control, and the duty cycle when the CCM acts is determined according to the rectified output VIN and the output voltage Vo.

In contrast, in the present invention, a feedforward control that naturally determines the duty cycle is further combined into the control circuit 3a, so that the burden of the feedback control can be reduced, and the operation can be made more stably/rapidly. Next, the feedforward control will be described.

Next, with respect to a conventional control and a control of the present invention, the relationships between the signal Vx and the superimposed signal Vosc serving as an input of the PWM comparator 34, and an output of the PWM comparator 34 are compared.

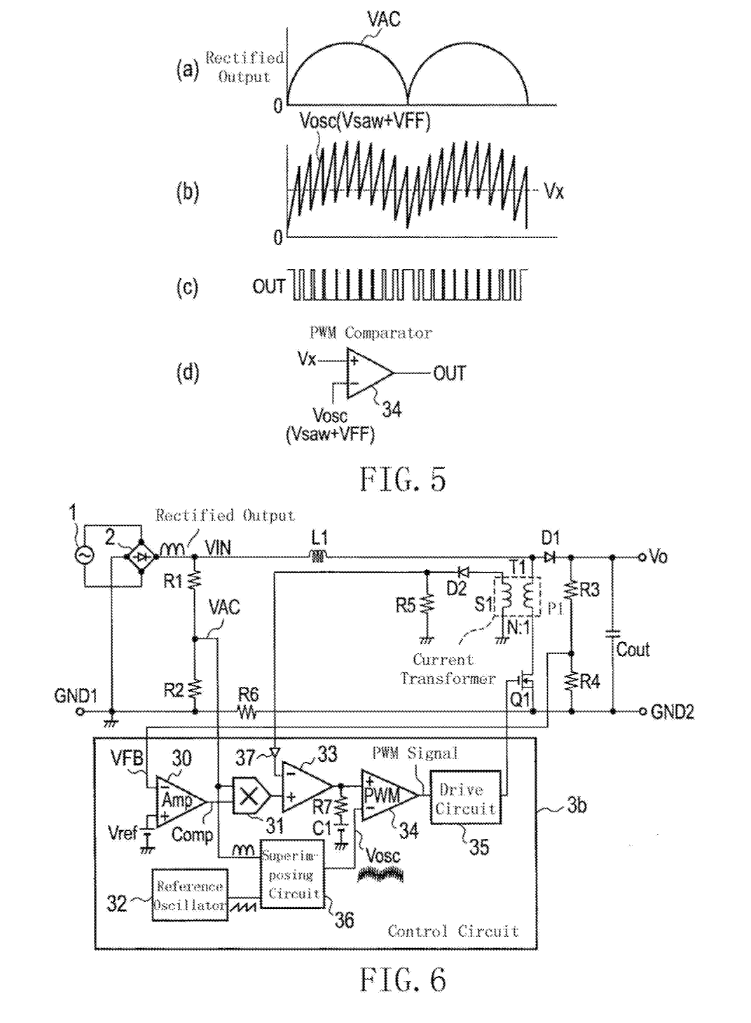

FIG. 4 illustrates an operation waveform of the conventional control, and FIG. 5 illustrates an operation waveform of the control in the present invention. FIG. 4(a) and FIG. 5(a) illustrate a rectified output VAC. FIG. 4(b) illustrates a sawtooth wave output Vsaw and a non-inverting input signal Vx of the PWM comparator 34. FIG. 5(b) illustrates a superimposed signal Vosc (=Vsaw+VFF) and a signal Vx. FIG. 4(c) and FIG. 5(c) illustrate an output OUT of the PWM comparator 34. FIG. 4(d) and FIG. 5(d) illustrate the PWM comparator 34.

In addition, Va is a lower limit value of the sawtooth wave output Vsaw, Vb is an upper limit value of the sawtooth wave output Vsaw, Doff is a cut-off duty cycle of the output of the PWM comparator, and VFB is a voltage obtained by resistively dividing the output voltage Vo using the resistor R3 and the resistor R4.

In the conventional control, as shown in equation (4), the signal Vx varies with the rectified divided voltage output VAC.

$$\begin{matrix}Δ Vm ≡ Vb - Va & ( 3 ) \\ Doff = \frac{Vb - Vx}{Δ Vm} & ( 4 )\end{matrix}$$

In a case where the CCM operates,

$$Doff = \frac{Vin}{Vout} \qquad ( 5 )$$

In a case where R1: R2=R3: R4, and an operation is made when the voltage VFB is equal to the reference voltage Vref, i.e., about 2.5V, the above equation is as follows:

$$Doff = \frac{VAC}{VFB} ≅ \frac{VAC}{2.5 V} \qquad ( 6 )$$

When it is solved according to equations (4) and (6) how the signal Vx changes when the PFC control is performed, the signal Vx varies with the rectified divided voltage output VAC, as shown in equation (5).

$$Vx = Vb - \frac{Δ Vm}{2.5} VAC \qquad ( 7 )$$

In the conventional control, as indicated by the dotted line in FIG. 4(b), the signal Vx is delayed relative to the rectified divided voltage output VAC because of the influence of the phase correction made by the phase correction circuit R7, C1 of the calculating unit 33. Therefore, the responsiveness is reduced and the power factor is reduced.

In contrast, in the control of the present invention, by making the signal Vx be a constant value or a substantially constant value, there does not exist the influence of the delay of the signal Vx relative to the rectified divided voltage output VAC, even if there is a delay due to the phase correction. That is, the responsiveness is good.

In the conventional CCMPFC, the PWM comparator 34 is used to compare the signal Vx with the sawtooth wave output Vsaw, and the average value of the input current I1 is controlled to be similar to the rectified output VIN. The duty cycle of the switching element Q1 is determined according to a ratio of the rectified output VIN to the output voltage Vo. The rectified output VIN will vary since it is a voltage obtained by rectifying the AC voltage. The signal Vx varies with the rectified output VIN serving as the rectified voltage.

In contrast, In Embodiment 1, as illustrated in FIG. 5(b), the rectified divided voltage output VAC synchronized with the rectified output VIN is superimposed on the sawtooth wave output Vsaw from the reference oscillator 32 to change the superimposed signal Vosc, so that the signal Vx is a constant value. Since the signal Vx is a constant value, the response characteristic is good even if there is a phase delay of the resistor R7 and the capacitor C1. Therefore, even if the signal Vx is a constant value, the duty cycle of the switching element Q1 is also controlled so that the output voltage Vo is constant.

Next, in a case where a VFF signal is applied to the sawtooth wave output Vsaw, a method for making the signal Vx be a constant value is derived from the equation.

$$VFF = \frac{Δ Vm}{2.5} VAC \qquad ( 8 )$$

The following equation is obtained through the PWM comparator 34.

$$Doff = \frac{Vb + VFF - Vx}{Δ Vm} = \frac{Vb}{Δ Vm} + \frac{VAC}{2.5} - \frac{Vx}{Δ Vm} \qquad ( 9 )$$

In a case where the CCM operates, the theoretical value of Doff is shown in equation (10), which is the same as the conventional control.

$$Doff = \frac{Vin}{Vout} \qquad ( 10 )$$

In a case where R1: R2=R3: R4, and an operation is made when the voltage VFB is equal to the reference voltage Vref, i.e., about 2.5V, Doff is represented by equation (11):

$$Doff = \frac{VAC}{VFB} ≅ \frac{VAC}{2.5 V} \qquad ( 11 )$$

When it is solved according to equations (9) and (11) how the signal Vx changes, the VAC component varying with the AC waveform is eliminated. As shown in equation (12), regardless of the commercial AC waveform, just let the signal Vx be an upper limit value Vb of the sawtooth wave output Vsaw. That is, the target duty cycle is obtained by the constant signal Vx.

Vx=Vb (1.2)

Therefore, by adding the superimposing circuit 36 that is relatively convenient, a feedforward signal can be generated in the duty cycle control of the CCMPFC. By adding a feedforward control, it is possible to reduce the feedback gain amount and perform operations stably/at a high speed.

Thus, in the conventional control, as illustrated in FIG. 4, the signal Vx that serves as the input signal of the PWM comparator 34 has a waveform similar and close to that of the rectified output VAC. In the control of the present invention, by adding a feedforward control, as illustrated in FIG. 5, the signal Vx is compared with the superimposed signal Vosc=Vsaw+VFF. As a result, the signal Vx becomes a voltage close to the DC voltage and is properly controlled. Since the signal Vx becomes a voltage close to the DC voltage, the influence of the phase correction is reduced and the responsiveness is improved. Thus, in Embodiment 1, as compared with the conventional control mode, even if the phase correction is alleviated, it is also possible to ensure the same or better responsiveness. Since the influence of the phase correction is reduced, the power factor is also improved as compared with the conventional control.

It is assumed that the turned-on duty cycle of the switching element Q1 becomes narrowed in a case where the superimposing circuit 36 serving as the feedforward circuit is failed and the feedforward amount is increased. Thus, it is safe since the output voltage Vo is decreased. In addition, in a case where the feedforward amount is decreased, the operation is made by the PFC having no feedforward. Therefore, although the power factor and the stability are reduced, there is no problem because it becomes a PFC control.

In addition, the present invention is described with the CCMPFC, but even for the current discontinuous mode power factor improvement circuit (DCMPFC), the control still can be made by decreasing the feedforward amount. Even for the CCMPFC, it becomes the DMPFC when the load current is small. In a case where a control is required in the DCM region, a control that decreases the feedforward amount is performed.

### Embodiment 2

FIG. 6 is a circuit structure diagram of a power factor improvement circuit of Embodiment 2. The power factor improvement circuit in Embodiment 1 detects the current I2 using the current detection resistor R6 and converts the detected current into a voltage. However, the efficiency is decreased when the current is converted into the voltage using the current detection resistor R6. The power factor improvement circuit in Embodiment 2 is characterized in that the current detection is performed using a current transformer T1.

The current transformer T1 comprises a primary winding P1 and a secondary winding S1 with a turns ratio of 1:N. The primary winding P1 is connected between the coil L1 and a drain of the switching element Q1. A series circuit of a diode D2 and a resistor R5 is connected to both ends of the secondary winding S1, and a signal CS1 at a connection point between the diode D2 and the resistor R5 is output to a current-voltage conversion circuit 37 of the control circuit 3b. The current transformer T1, the diode D2, and the resistor R5 constitute a current detector that detects the current flowing through the switching element Q1. The current-voltage conversion circuit 37 outputs a voltage VL proportional to the current detected by the current detector to the inverting input terminal of the calculating unit 33.

In this way, since the power factor improvement circuit according to Embodiment 2 uses the current transformer T1 to perform a current detection, it is more efficient than the power factor improvement circuit according to Embodiment 1.

### Embodiment 3

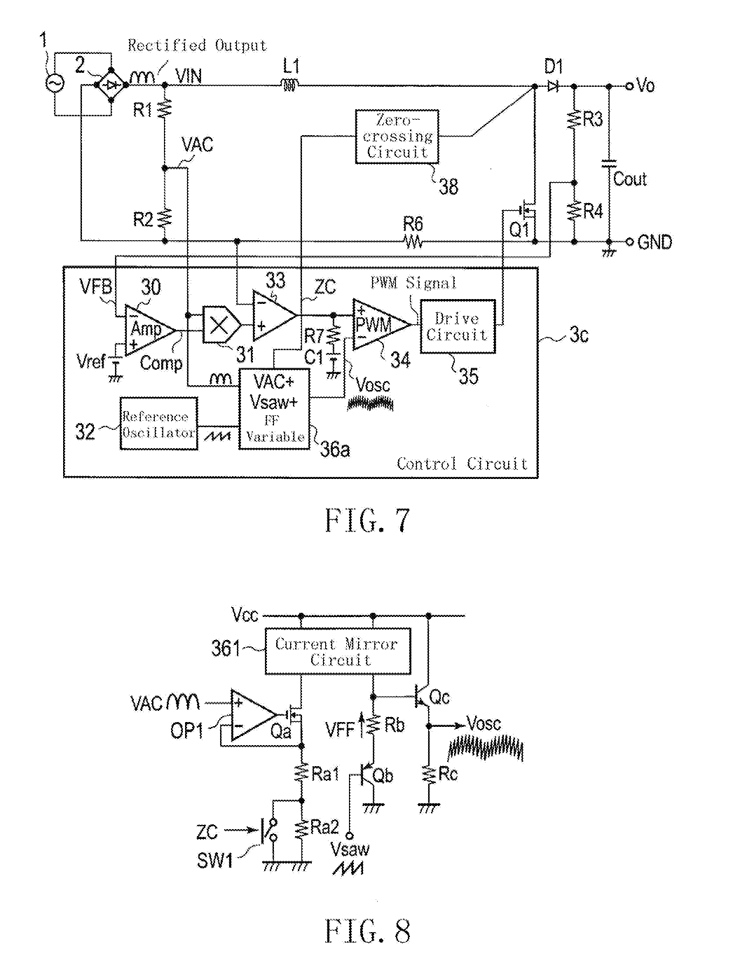

FIG. 7 is a circuit structure diagram of a power factor improvement circuit of Embodiment 3. The power factor improvement circuit of Embodiment 3 is characterized in that a zero-crossing circuit 38 is provided. The zero-crossing circuit 38 is connected to a connection point between the coil L1 and the diode D1, determines whether the current flowing through the coil L1 is in a continuous region or a discontinuous region by detecting a voltage at the connection point between the coil L1 and the diode D1, and outputs the determination output to the superimposing circuit 36a. The zero-crossing circuit 38 is corresponding to a region determining unit of the present invention.

FIG. 8 is a circuit structure diagram of a superimposing circuit 36a disposed in the power factor improvement circuit of Embodiment 3. The superimposing circuit 36a switches a ratio at which a signal based on the output of the rectifying circuit 2 is superimposed on a reference signal of the reference oscillator 32, depending on the continuous region or the discontinuous region. As illustrated in FIG. 8, in the superimposing circuit 36a, a source of the MOSFET Qa is connected in series with a resistor Ra1 and a resistor Ra2. Both ends of the resistor Ra2 are connected in parallel with a switch SW1.

The switch SW1 is turned on and off according to the determination output of the zero-crossing circuit 38. When the switch SW1 is turned on, the leakage current of the MOSFET Qa increases, and the superimposed signal Vosc increases. In addition, when the switch SW1 is turned off, the leakage current of the MOSFET Qa decreases, and the superimposed signal Vosc decreases. That is, the feedforward amount is switched by turning on and off the switch SW1. Thus, an optimum feedforward amount can be set depending on whether the current flowing through the coil L1 is in a continuous region or a discontinuous region.

### Embodiment 4

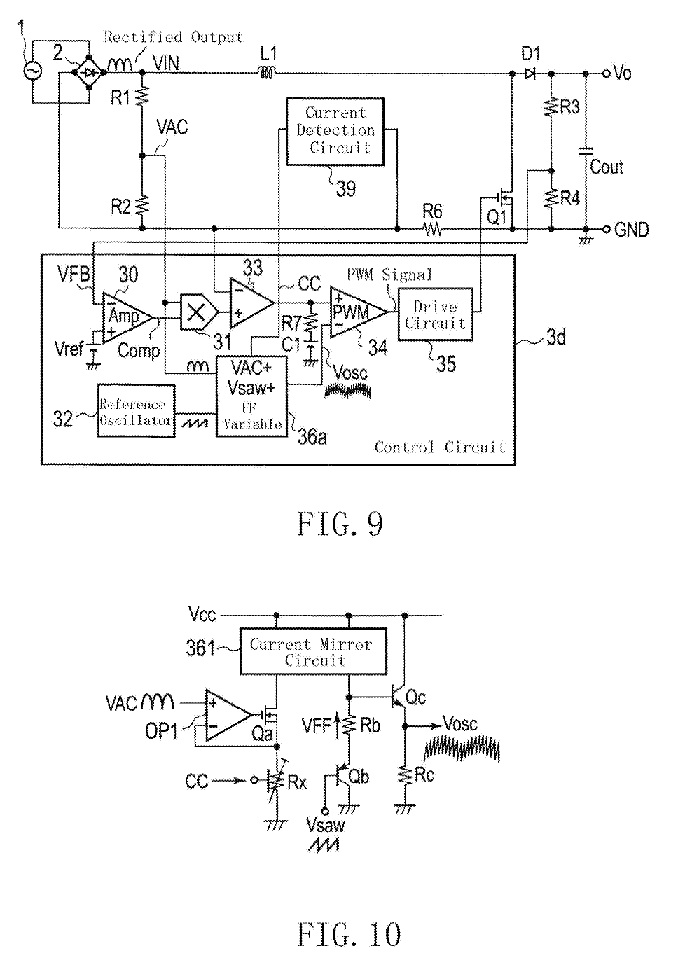

FIG. 9 is a circuit structure diagram of a power factor improvement circuit of Embodiment 4. The power factor improvement circuit of Embodiment 4 is characterized in that a current detection circuit 39 is provided. The current detection circuit 39 is connected to the current detection resistor R6 and detects a load current using the current detection resistor R6.

FIG. 10 is a circuit structure diagram of a superimposing circuit 36a provided in the power factor improvement circuit of Embodiment 4. The superimposing circuit 36a includes a variable resistor Rx connected to a drain of the MOSFET Qa. The superimposing circuit 36a can change the feedforward amount that is a ratio at which a signal based on the output of the rectifying circuit 2 is superimposed on a reference signal of the reference oscillator 32. The variable resistor Rx can change the resistance value, so that it becomes a feedforward amount corresponding to the load current detected by the current detection circuit 39. Thus, the feedforward amount can be continuously set according to a current flowing through the coil L1. In particular, a feedforward amount corresponding to the discontinuous amount can be set in a discontinuous region of the current flowing through the coil L1.

### Embodiment 5

FIG. 11 is a circuit structure diagram of a boost type DC/DC converter of Embodiment 5. Embodiment 5 is characterized in that the AC power supply 1 serving as the input power supply of Embodiment 1 is changed into a DC power supply Vin. An input capacitor Cin, as well as a series circuit of the resistor R1 and the resistor R2, is connected in parallel to both ends of the DC power supply Vin. The superimposing circuit 36 superimposes a signal based on an output of the DC power supply Vin on the reference signal of the reference oscillator 32. The PWM comparator 34 generates a pulse signal by comparing an error voltage between an output voltage of the smoothing capacitor Co and a reference voltage Vref with an output of the superimposing circuit 36, and turns on/off the switching element Q1 with the pulse signal. In Embodiment 1, the input voltage is a commercial AC voltage and the boost type PFC control is described, but the input voltage may also be a DC voltage. In a case where the input voltage is a DC voltage, the responsiveness of the output voltage can be improved by a feedforward control that superimposes the input voltage on the sawtooth wave output, even if a variation occurs due to an instantaneous interrupt of the input power supply or a load adjustment. The boost type DC/DC converter of Embodiment 5 may also be added with the zero-crossing circuit 38 and the switch SW1 for adjusting the feedforward amount in Embodiment 3, or the current detection circuit 39 and the variable resistor Rx for adjusting the feedforward amount in Embodiment 4.

### Embodiment 6

FIG. 12 illustrates a buck type DC/DC converter circuit of Embodiment 6. The output terminal of the DC power supply Vin of the buck type DC/DC converter is connected to a source of the switching element Q1, and a drain of the switching element Q1 is connected to a cathode of the diode D1 and one end of the coil L1. Even for the buck type DC/DC converter, the responsiveness of the output voltage can be improved by a feedforward control that superimposes the input voltage on the sawtooth wave output, in a case where a variation occurs due to an instantaneous interrupt of the input power supply or a load adjustment. The buck type DC/DC converter of Embodiment 6 may also be added with the zero-crossing circuit 38 and the switch SW1 for adjusting the feedforward amount in Embodiment 3, or the current detection circuit 39 and the variable resistor Rx for adjusting the feedforward amount in Embodiment 4.

### Embodiment 7

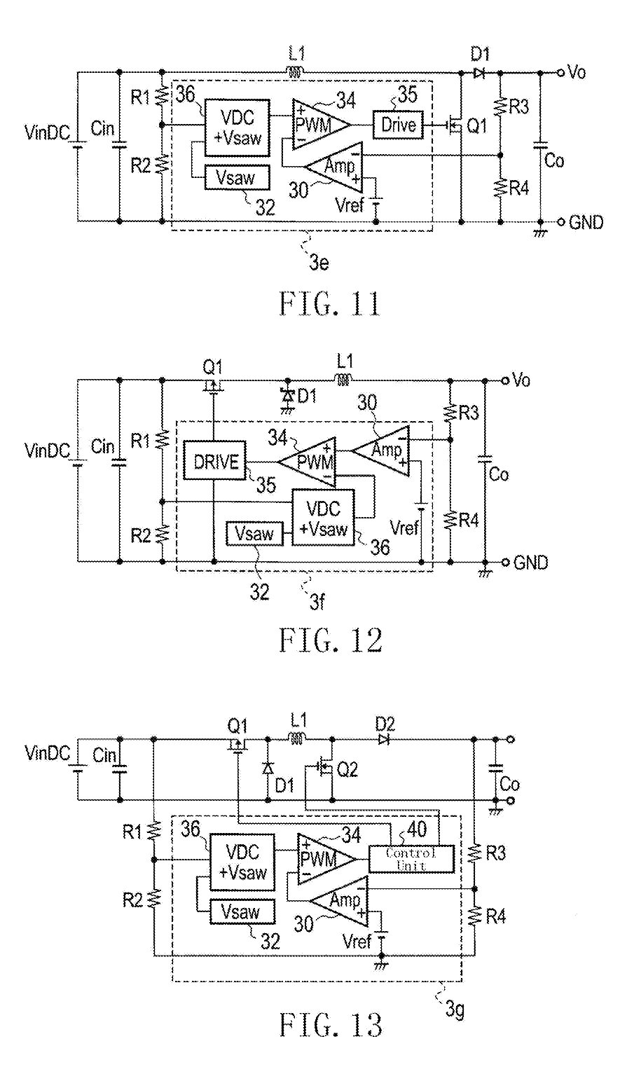

FIG. 13 illustrates a boost and buck type DC/DC converter circuit of Embodiment 7. The switching element Q1 and the coil L1 are connected in series to the output terminal of the DC power supply Vin of the boost and buck type DC/DC converter, the diode D1 is connected to a connection point between the switching element Q1 and the coil L1, and the switching element Q2 is connected to a connection point between the coil L1 and the diode D2. A control unit 40 generates a first pulse signal and a second pulse signal by comparing an error voltage between an output voltage of the smoothing capacitor Co and a reference voltage Vref with an output of the superimposing circuit 36, turns on/off the switching element Q1 with the first pulse signal, and turns on/off the switching element Q2 with the second pulse signal. As for the boost and buck type DC/DC converter, the responsiveness of the output voltage can be improved by a feedforward control that superimposes the input voltage on the sawtooth wave output, in a case where a variation occurs due to an instantaneous interrupt of the input power supply or a load adjustment.

In addition, the present invention is not limited to the power factor improvement circuit and the DC/DC converter of Embodiments 1 to 7. In Embodiments 1 to 7, the switching element Q1 is an MOSFET, but it may also be a semiconductor switch other than the MOSFET, such as IGBT and bipolar transistor.

In the power factor improvement circuit of Embodiments 1 to 5, the rectifying element is a diode, but it may also be a semiconductor switch other than the diode.

### INDUSTRIAL APPLICABILITY

The present invention can be applied to the DC/DC converter.

### EXPLANATION OF REFERENCE NUMERALS

1: AC power supply; 2: rectifier; 3A and 3a to 3g: control circuit; 30: error amplifier; 31: multiplier; 32: reference oscillator; 33: calculating unit; 34: PWM comparator; 35: drive circuit; 36 and 36a: superimposing circuit; 37: current-voltage conversion circuit; 38: zero-crossing circuit; 39: current detection circuit; 40: control unit; 361: current mirror circuit; L1: coil; T1: current transformer; D1 and D2: diode; Q1 and Q2: switching element; OP1: operational amplifier; R1 to R6: resistor; Co: output capacitor; Cin: input capacitor.

1-10. (canceled)

11. A power factor improvement circuit, comprising:
a rectifying circuit configured to rectify an AC voltage of an AC power supply;
a series circuit consisting of a coil and a switching element connected in series to an output terminal of the rectifying circuit;
a rectifying and smoothing circuit consisting of a rectifying element and a smoothing capacitor connected in series between main electrodes of the switching element;
a calculating unit configured to calculate a multiplied voltage and a voltage corresponding to a current flowing through the switching element or a current from the output terminal of the rectifying circuit, said multiplied voltage being obtained by multiplying an error voltage between an output voltage of the smoothing capacitor and a reference voltage by an output of the rectifying circuit;
a reference oscillator configured to generate a reference signal;
a superimposing circuit configured to superimpose a signal based on the output of the rectifying circuit on the reference signal of the reference oscillator; and
a control circuit configured to generate a pulse signal by comparing an output of the superimposing circuit with an output from the calculating unit, and turn on/off the switching element with the pulse signal.

12. The power factor improvement circuit according to claim 11, wherein the output from the calculating unit is a constant voltage or a pulsating voltage consisting of a substantially constant voltage.

13. The power factor improvement circuit according to claim 11, wherein the power factor improvement circuit comprises a current detection circuit configured to detect a load current flowing through a load,
the superimposing circuit is configured to change a ratio at which the signal based on the output of the rectifying circuit is superimposed on the reference signal of the reference oscillator, according to the load current detected by the current detection circuit.

14. The power factor improvement circuit according to claim 12, wherein the power factor improvement circuit comprises a current detection circuit configured to detect a load current flowing through a load,
the superimposing circuit is configured to change a ratio at which the signal based on the output of the rectifying circuit is superimposed on the reference signal of the reference oscillator, according to the load current detected by the current detection circuit.

15. The power factor improvement circuit according to claim 11, wherein the power factor improvement circuit comprises a region determining unit configured to determine whether a current flowing through the coil is in a continuous region or a discontinuous region,
the superimposing circuit is configured to switch a ratio at which the signal based on the output of the rectifying circuit is superimposed on the reference signal of the reference oscillator, depending on the continuous region or the discontinuous region determined by the region determining unit.

16. The power factor improvement circuit according to claim 12, wherein the power factor improvement circuit comprises a region determining unit configured to determine whether a current flowing through the coil is in a continuous region or a discontinuous region,
the superimposing circuit is configured to switch a ratio at which the signal based on the output of the rectifying circuit is superimposed on the reference signal of the reference oscillator, depending on the continuous region or the discontinuous region determined by the region determining unit.

17. A DC/DC converter, comprising:
a DC power supply;
a converter unit in which an end of a coil is connected to an output terminal of the DC power supply, and the other end of the coil is connected to a switching element and a rectifying element;
a smoothing capacitor connected to an output terminal of the converter unit;
a reference oscillator configured to generate a reference signal;
a superimposing circuit configured to superimpose a signal based on an output of the DC power supply on the reference signal of the reference oscillator; and
a control circuit configured to generate a pulse signal by comparing an error voltage between an output voltage of the smoothing capacitor and a reference voltage with an output of the superimposing circuit, and turn on/off the switching element with the pulse signal.

18. The DC/DC converter according to claim 17, wherein the error voltage is a constant voltage or a pulsating voltage consisting of a substantially constant voltage.

19. The DC/DC converter according to claim 17, wherein the DC/DC converter comprises a current detection circuit configured to detect a load current flowing through a load,
the superimposing circuit configured to change a ratio at which the signal based on the output of the DC power supply is superimposed on the reference signal of the reference oscillator, according to the load current detected by the current detection circuit.

20. The DC/DC converter according to claim 17, wherein the DC/DC converter comprises a region determining unit configured to determine whether a current flowing through the coil is in a continuous region or a discontinuous region,
the superimposing circuit is configured to switch a ratio at which the signal based on the output of the DC power supply is superimposed on the reference signal of the reference oscillator, depending on the continuous region or the discontinuous region determined by the region determining unit.

21. A DC/DC converter, comprising:
a DC power supply;
a converter unit in which an end of a switching element is connected to an output terminal of the DC power supply, and the other end of the switching element is connected to a rectifying element and a coil;
a smoothing capacitor connected to an output terminal of the converter unit;
a reference oscillator configured to generate a reference signal;
a superimposing circuit configured to superimpose a signal based on an output of the DC power supply on the reference signal of the reference oscillator; and
a control circuit configured to generate a pulse signal by comparing an error voltage between an output voltage of the smoothing capacitor and a reference voltage with an output of the superimposing circuit, and turn on/off the switching element with the pulse signal.

22. The DC/DC converter according to claim 21, wherein the error voltage is a constant voltage or a pulsating voltage consisting of a substantially constant voltage.

23. The DC/DC converter according to claim 21, wherein the DC/DC converter comprises a current detection circuit configured to detect a load current flowing through a load,
the superimposing circuit configured to change a ratio at which the signal based on the output of the DC power supply is superimposed on the reference signal of the reference oscillator, according to the load current detected by the current detection circuit.

24. The DC/DC converter according to claim 21, wherein the DC/DC converter comprises a region determining unit configured to determine whether a current flowing through the coil is in a continuous region or a discontinuous region, the superimposing circuit is configured to switch a ratio at which the signal based on the output of the DC power supply is superimposed on the reference signal of the reference oscillator, depending on the continuous region or the discontinuous region determined by the region determining unit.

25. A DC/DC converter, comprising:
a DC power supply;
a converter unit in which a first switching element and a coil are connected in series to an output terminal of the DC power supply, a first rectifying element is connected to a connection point between the first switching element and the coil, and a second switching element is connected to a connection point between the coil and a second rectifying element;
a smoothing capacitor connected to an output terminal of the converter unit;
a reference oscillator configured to generate a reference signal;
a superimposing circuit configured to superimpose a signal based on an output of the DC power supply on the reference signal of the reference oscillator; and
a control circuit configured to generate a first pulse signal and a second pulse signal by comparing an error voltage between an output voltage of the smoothing capacitor and a reference voltage with an output of the superimposing circuit, turn on/off the first switching element with the first pulse signal, and turn on/off the second switching element with the second pulse signal.

26. The DC/DC converter according to claim 25, wherein the error voltage is a constant voltage or a pulsating voltage consisting of a substantially constant voltage.

27. The DC/DC converter according to claim 25, wherein the DC/DC converter comprises a current detection circuit configured to detect a load current flowing through a load,
the superimposing circuit configured to change a ratio at which the signal based on the output of the DC power supply is superimposed on the reference signal of the reference oscillator, according to the load current detected by the current detection circuit.

28. The DC/DC converter according to claim 25, wherein the DC/DC converter comprises a region determining unit configured to determine whether a current flowing through the coil is in a continuous region or a discontinuous region,
the superimposing circuit is configured to switch a ratio at which the signal based on the output of the DC power supply is superimposed on the reference signal of the reference oscillator, depending on the continuous region or the discontinuous region determined by the region determining unit.
